(19) United States
(12) Patent Application Publication
(10) Pub. No.: US 2010/0200077 A1
(43) Pub. Date: Aug. 12, 2010

(54) PLUMBING FIXTURE TRIM SNAP CONNECT

(76) Inventors: Anthony Chan, Sierra Madre, CA (US); Tracy James Haeggstrom, Orange, CA (US)

Correspondence Address: LAUSON & TARVER LLP, 880 APOLLO STREET, SUITE 301, EL SEGUNDO, CA, 90245, US

(21) Appl. No.: 12/704,410

(22) Filed: Feb. 11, 2010

Related U.S. Application Data
(60) Provisional application No. 61/207,691, filed on Feb. 12, 2009.

(51) Int. Cl. F16K 43/00

(52) U.S. Cl. 137/15.18; 137/315.01

(57) ABSTRACT

A plumbing fixture trim snap connect comprises a faucet handle assembly and a base assembly. The faucet handle assembly includes an escutcheon bearing upper and lower internal tabs, freely rotatable around a faucet handle. The base assembly includes a base seat on which a spring and retainer are maintained in an upwardly biased position. The seat includes a groove and helical cut, and the retainer includes indents in its surface to accommodate the upper and lower tabs of the escutcheon. By pushing the escutcheon down atop the base assembly and rotating the escutcheon relative to the base assembly, the apparatus can be assembled. Disassembly can be accomplished simply by rotating the escutcheon in the opposite direction.

This application claims the benefit of the filing date of provisional application No. 61/207,691, filed on Feb. 12, 2009.

### BACKGROUND

Faucets and faucet handle escutcheons are known in the art, as are methods and apparatus for attaching these items to valve bases for anchorage, and to operate water valves. Heretofore, installing and uninstalling these components required qualified plumbers or skilled handypersons employing a variety of hand tools such as wrenches and/or pliers. Escutcheons moreover, are prone to gradually separate from the surface onto which a plumbing trim fixture is installed, creating both an unsightly appearance and providing access between wall interiors and exteriors through which insects and vermin might pass.

It is therefore an object of the present invention to provide an improved plumbing trim connection that can be easily installed and uninstalled, while also providing an escutcheon not prone to separation from the surface against which it is positioned. A further object of the invention is to provide a plumbing trim fixture that can be installed and uninstalled manually, without the use of hand tools. Yet another embodiment is to provide a plumbing fixture allowing removal of the handle and faucet assembly while allowing the base to remain attached to an installation surface. These and other objects of the invention will become better understood through the appended Summary, Description and Claims.

### SUMMARY

In order to solve existing problems in the art, a manually connecting and disconnecting plumbing trim apparatus is proposed. The apparatus principally includes a handle assembly including a faucet handle, escutcheon and stem nut holding the handle assembly together, while allowing the faucet handle to rotate relative to the escutcheon. The trim apparatus also includes a base assembly, including a retainer, spring and valve base with a seat for accommodating the escutcheon.

The back of the escutcheon includes a series of lower tabs and a series of upper tabs on its underside surface for engaging the base assembly. The top of the base assembly includes a seat for holding the spring and retainer. The seat maintains the spring and retainer in position by restraints that hold the retainer and spring within the confines of the seat while allowing the spring to urge the retainer up against the restraints. The restraints rest in indentations on the retainer to prevent lateral rotation of the retainer relative to the seat.

The seat includes a series of grooves corresponding to the lower tabs on the escutcheon. Each groove also contains a helical cut extending away from the groove. A lower tab, therefore, may be urged downward into a groove and then with rotational movement, brought under the helical cut, causing the lower tab to tighten against the seat.

The retainer includes a series of cut-outs, or indents, around its outside edge, each indent associated with an upper tab of the escutcheon. In this manner, the upper tabs may push down the retainer, compressing the spring as the lower tabs engage grooves on the seat. Then, as the lower tabs rotate into the helical cuts, the upper tabs rotate along the retainer's top surface toward the retainer indents.

As the lower tabs reach the termini of the helical cuts, the upper tabs move into the indents, causing the spring to urge the retainer up, locking the upper tabs in position. It has been found that by including an angled portion to the indents, the upper tabs may be urged out of them by applying sufficient reverse rotational movement, thereby re-depressing the retainer and rotating atop it to a disassembling position.

Once the escutcheon has been placed over the seat with downward pressure, the lower tabs aligned with the grooves, the lower tabs may be rotated into the helical cuts. As the lower tabs move down and rotate into the helical cuts, the upper tabs urge the retainer downward against the spring. By rotating the escutcheon in position relative to the seat, the upper tabs travel along the top surface of the depressed retainer. To prevent the retainer from rotating in tandem with the escutcheon, the restraints of the seat align with indentations in the retainer to permit depression of the retainer without allowing the restraints to escape the indentations.

The helical cuts have terminal ends, and when the lower tabs meet the terminal ends and stop rotational movement, the upper tabs simultaneously move into the indents. The indents in the retainer also have angled portions over which the upper tabs slide when entering and exiting the indents. The angled portion allows a user to disassemble the assembly by reverse rotational movement of the escutcheon. Opposite the angled portion, the indents have vertical side walls preventing continued forward rotational movement of the upper tabs.

With the escutcheon pushed down against the seat, the lower tabs disposed in the grooves, and the escutcheon rotated until the upper tabs are disposed in the indents, and the lower tabs disposed in the helical cuts, assembly is complete. To disassemble the device, a user need only rotate the escutcheon in a reverse direction, urging the upper tab over the angled portion and out of the indents. Once the lower tabs reach the grooves, the handle assembly can be removed from the base. In this manner, both handles and faucets incorporating the assembly of the present invention may be removed and replaced with new fixtures without removing the bases from their points of installation.

### BRIEF DESCRIPTION OF THE FIGURES

FIG. 1 is an exploded view of the faucet handle assembly of the present invention.

FIG. 2 is a partially exploded view of the faucet handle, showing the assembled handle/escutcheon assembly and assembled base assembly.

FIG. 3 is a bottom perspective view of the handle assembly of the present invention, showing the underside of the escutcheon in detail.

FIG. 4 is a perspective view of the top of the base assembly, showing the seat, retainer, and spring.

FIG. 5 is a cut away view of the escutcheon interfacing with the seat, wherein a lower tab is aligned within a seat groove.

FIG. 6 is a cut away view of the escutcheon interfacing with the seat, wherein an upper tab rests atop the retainer.

FIG. 7 is a cut away view of the escutcheon, wherein the upper tab has situated in an indent of the retainer.

FIG. 8 is a perspective partially exploded view of the invention wherein the escutcheon is adapted to connect a faucet to the base assembly.

### DESCRIPTION

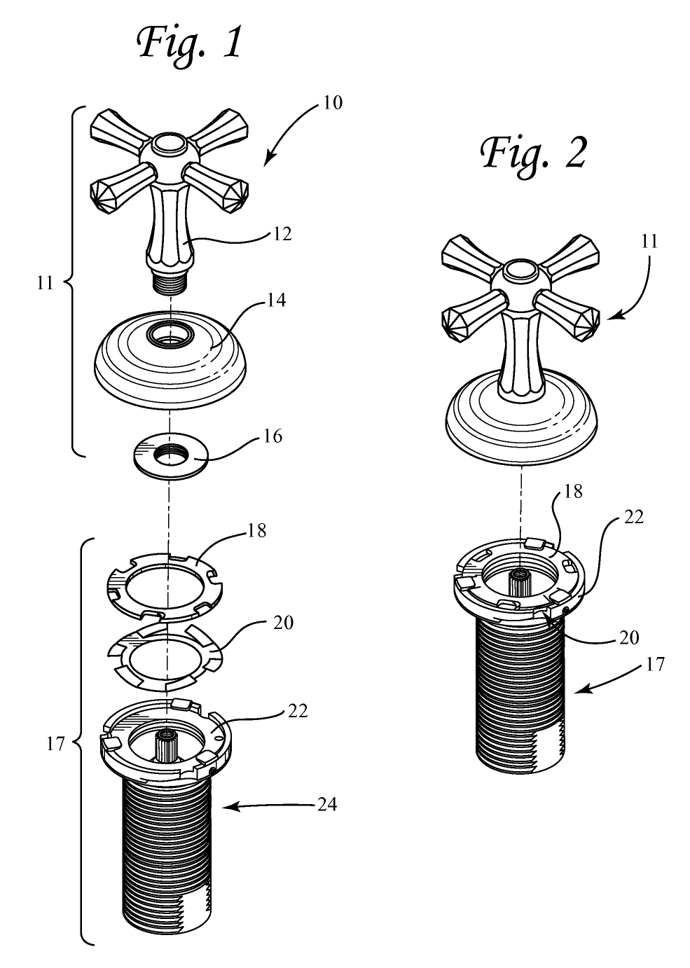

Referring to FIG. 1, a manually connecting and disconnecting plumbing trim apparatus is shown and described. The apparatus 10 includes a handle assembly 11 comprising a faucet handle 12 interfacing with an escutcheon 14 and a stem nut 16 adapted to hold the faucet handle 12 adjacent the escutcheon 14 while allowing the faucet handle 12 to rotate relative to the escutcheon 14. The apparatus 10 also includes a base assembly 17 comprising a retainer 18, a spring 20 and a seat 22 atop a valve base 24. Referring to FIG. 2, the handle assembly 11 fastens onto the base assembly 17 by interfacing with the seat 22, spring 20, and retainer 18.

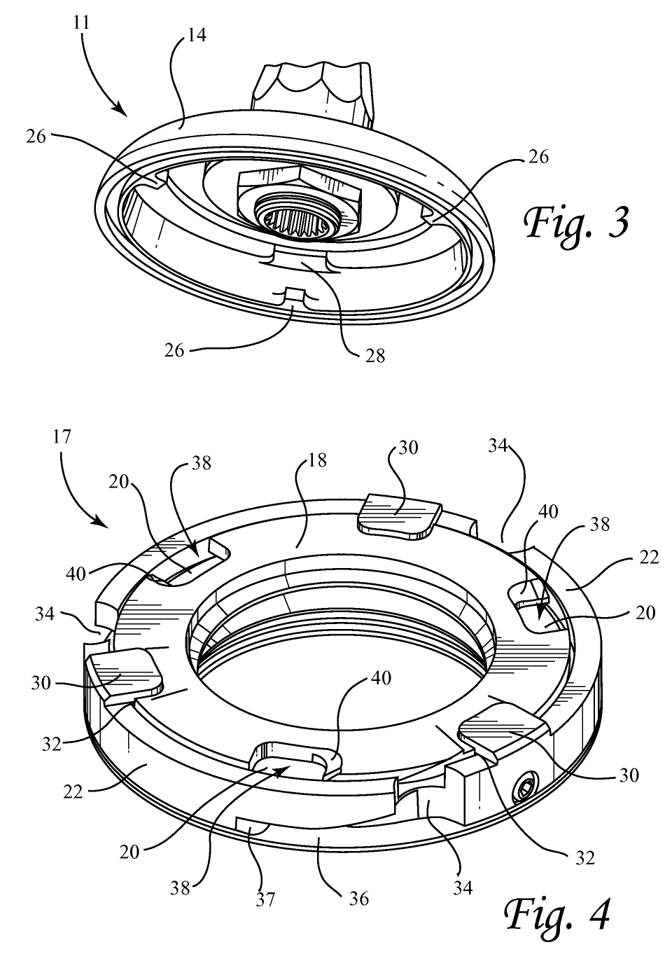

Referring to FIG. 3, the underside of the handle assembly 11 is shown and described. The escutcheon 14 of the handle assembly 11 comprises a series of lower tabs 26 and a series of upper tabs 28 on its underside. In another embodiment, the upper tabs may also comprise slopes or angles at their edges to facilitate interfacing with other parts of the assembly.

Referring to FIG. 4, a close up perspective view of the base assembly 17 top surface is shown. The top of the base assembly 17 comprises a seat 22 holding the spring 20 and retainer 18. The seat 22 holds the spring 20 and retainer 18 in position by virtue of a series of restraints 30 that secure the retainer 18 and spring 20 within the confines of the seat 22. To prevent rotational movement of the retainer 18 relative to the seat 22, the restraints 30 are disposed in indentations 32 on the retainer 18.

Still referring to FIG. 4, the seat 22 comprises a series of grooves 34 corresponding to the lower tabs 26 (see FIG. 3). Each groove 34 is associated with a helical cut 36 extending in one direction away from and at the bottom of the groove 34. In this manner, a lower tab 26 may be urged downward into a groove 34, and then with rotational movement of the escutcheon 14 (see FIG. 3), brought under the helical cut 36, moving the lower tab 26 further downward relative to the seat 22, and preserving it in that position.

Still referring to FIG. 4, the retainer 18 comprises a series of indents 38 wherein each indent 38 is associated with an upper tab 28 (see FIG. 3). In this manner, the upper tabs 28 contact the top of the retainer 18, forcing the retainer 18 down against the spring 20 as the lower tabs 26 engage the grooves 34 on the seat 22. As the lower tabs 26 rotate into the helical cuts 36, the upper tabs 28 slide along the top surface of the retainer 18 toward the indents 38.

Still referring to FIG. 4, as the lower tabs 26 reach the termini 37 of the helical cuts 36, the upper tabs 28 move into the indents 38, causing the spring 20 to urge the retainer 18 up, releasably locking the upper tabs 28 in position. Preferably, the indents 38 also comprise an angled portion 40 so that by applying sufficient reverse rotational motion, the upper tabs 28 are urged out of the indents 38, re-depressing the retainer 18, and rotating atop it to a disassembling position.

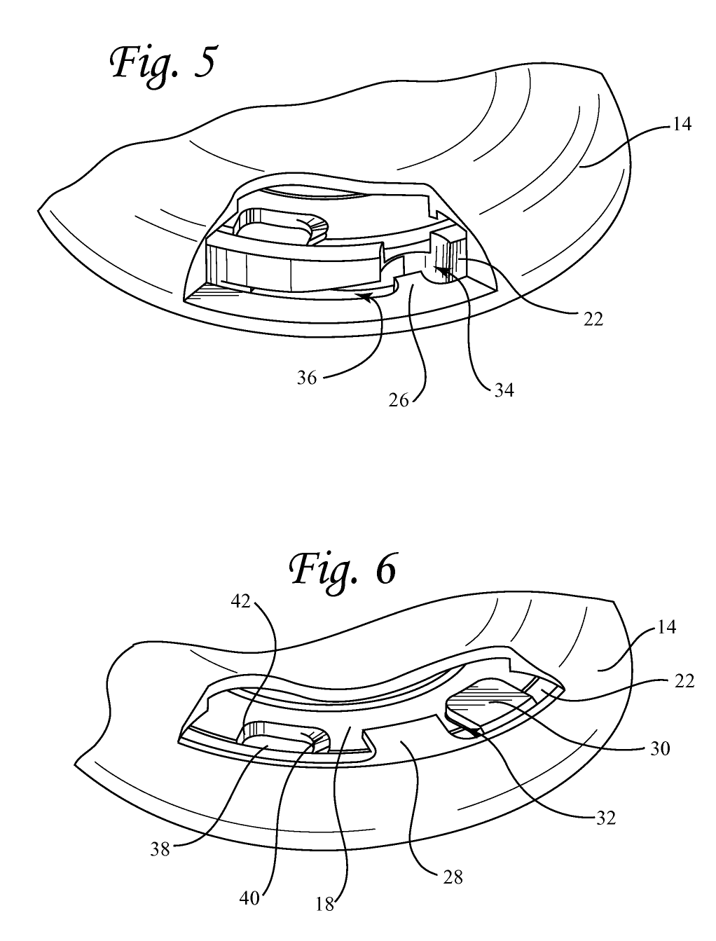

Referring to FIG. 5, a cut away view is shown wherein the escutcheon 14 has been placed over the seat 22 with downward pressure. By aligning the lower tabs 26 with the grooves 34, the lower tabs 26 may be urged into the grooves 34 and rotated into the helical cuts 36. As the lower tabs 26 move down and rotate into the helical cuts 36, the upper tabs, as shown in FIG. 3, urge the retainer 18 downward against the spring 20 as shown in FIG. 4.

Referring to FIG. 6, another cut away view is shown wherein in the escutcheon 14 has been placed over the seat 22 and downward pressure applied. By rotating the escutcheon 14 in position relative to the seat 22, the upper tabs 28 rotate over the top surface of the depressed retainer 18. During this action, the lower tabs 26 travel into the helical cuts 36 as shown in FIG. 5. To prevent the retainer 18 from rotating in tandem with the escutcheon 14, the restraints 30 of the seat 22 are aligned with indentations 32 in the retainer 18. Preferably, the retainer 18 indentations 32 are sufficiently deep to permit upper tab 28 depression of the retainer 18 without allowing the restraints 30 to escape the indentations 32.

Still referring to FIG. 6, the indents 38 in the retainer 18 comprise an angled portion 40 over which the upper tabs 28 slide when entering and exiting the indents 38. The angled portion allows disassembly of the escutcheon 14 and seat 22 by reverse rotational movement. Opposite the angled portion 40, the indents 38 have vertical side walls 42 preventing continued motion of the upper tabs 28 once secured in the indents 38.

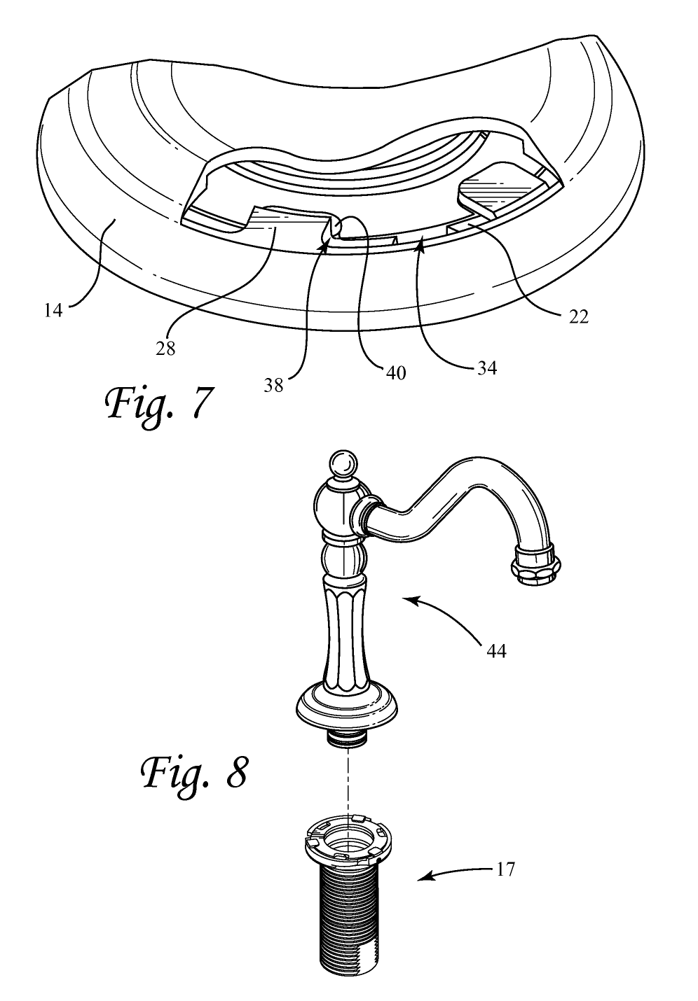

Referring to FIG. 7, once the escutcheon 14 has been pressed against the seat 22, with the lower tabs 26 as shown in FIG. 5 disposed in the grooves 34, and the escutcheon 14 rotated until the upper tabs 28 are disposed in the indents 38, assembly is complete. In order to disassemble the device, a user need only rotate the escutcheon 14 in a reverse direction, urging the upper tab 28 over the angled portion 40 and out of the indents 38. Once the lower tabs 26 reach the grooves 34 as shown in FIG. 5, the handle assembly 11 may be removed from the base 17 as shown in FIG. 2.

Referring to FIG. 8, while a faucet handle and escutcheon assembly has been shown and described in the present embodiment, other contemplated embodiments include a similar escutcheon 14 associated with a faucet 44, wherein the faucet 44 may be manually connected to the base 17.

Although the present invention has been described in considerable detail with reference to certain preferred versions thereof, other versions are possible. For instance the escutcheon and base assembly may be used for outdoor fixtures, and other areas where a tool-less quick disassembly is desirable. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. A manually connecting and disconnecting plumbing trim apparatus, comprising;
an escutcheon with at least one lower tab and at least one upper tab facing inward;
a base comprising a seat and a retainer biased to a raised position relative to the seat, said seat having at least one groove associated with a helical cut, and said retainer having at least one indent;
said escutcheon adapted to align with and engage said seat and said retainer, wherein said at least one lower tab engages said at least one grove, and rotates into said helical cut, and said at least one upper tab rotates over said retainer and engages said at least one indent; and
wherein upward pressure on said retainer maintains said at least one upper tab in said indent.

2. The manually connecting and disconnecting plumbing trim apparatus of claim 1 wherein said escutcheon is adapted to engage a faucet handle.

3. The manually connecting and disconnecting plumbing trim apparatus of claim 2 wherein a stem nut fastens said faucet handle to said escutcheon, thereby permitting said escutcheon to rotate freely about said faucet handle.

4. The manually connecting and disconnecting plumbing trim apparatus of claim 1 wherein said seat comprises at least one member for restraining said retainer, and preventing rotational movement of said retainer relative to said seat.

5. The manually connecting and disconnecting plumbing trim apparatus of claim 1 wherein a spring disposed between said retainer and said seat biases said retainer to a raised position.

6. The manually connecting and disconnecting plumbing trim apparatus of claim 1 wherein said lower tab and said upper tab are aligned in a manner causing said upper tab to press said retainer down relative to said seat as said lower tab enters said groove.

7. The manually connecting and disconnecting plumbing trim apparatus of claim 1 wherein said helical cut is incorporated into said groove in a manner such that as said lower tab moves laterally into said helical cut, said escutcheon is urged toward said base.

8. The manually connecting and disconnecting plumbing trim apparatus of claim 1 wherein said indent is aligned with said groove in a manner such that as said lower tab encounters a terminus in said helical cut, said upper tab aligns with said indent causing said upper tab to move at least partially into and engage said indent.

9. The manually connecting and disconnecting plumbing trim apparatus of claim 1 wherein said at least one indent comprises an inclined surface allowing said at least one upper tab to engage and disengage said at least one indent under rotational movement of said escutcheon relative to said base.

10. The manually connecting and disconnecting plumbing trim apparatus of claim 1 wherein said escutcheon is adapted to engage a faucet.

11. A manually connecting and disconnecting plumbing trim apparatus, comprising;
A faucet handle assembly comprising an escutcheon with at least one lower tab and at least one upper tab on its interior surface, a faucet handle stem, and a faucet handle stem nut, assembled in a manner permitting said escutcheon to turn freely about said faucet handle stem;
a base assembly comprising a seat, a spring, and a retainer wherein said spring biases said retainer to a raised position relative to said seat, said seat having at least one member for retaining said retainer and preventing rotational movement of said retainer relative to said seat, and at least one groove associated with a helical cut, and said retainer having at least one indent;
wherein said escutcheon aligns with and engages said base assembly seat and said retainer in a manner wherein said at least one lower tab engages said at least one grove, and rotates into said helical cut, while said at least one upper tab rotates atop said retainer and engages said at least one indent; and
wherein upward pressure on said retainer maintains said at least one upper tab in said indent once in position.

12. A method of providing a manually connecting and disconnecting faucet handle comprising the steps of:
providing a faucet handle and escutcheon assembly;
providing a base assembly;
aligning said faucet handle and escutcheon assembly over said base assembly;
pressing said faucet handle and escutcheon assembly downward onto said base assembly, and while said assemblies are under pressure, rotating said escutcheon of said faucet handle and escutcheon assembly relative to said base assembly to releasably connect said faucet handle and escutcheon assembly with said base assembly; and
wherein said faucet handle and escutcheon assembly may be removed from said base assembly by rotating said escutcheon of said faucet handle and escutcheon assembly in a direction opposite the direction of rotation for attachment.
